(19) United States
(12) Patent Application Publication
(10) Pub. No.: US 2010/0029418 A1
(43) Pub. Date: Feb. 4, 2010

(54) COMPOSITE BASEBALL BAT AND MANUFACTURING METHOD THEREOF

(76) Inventor: YUNG-HSIUNG CHEN, Apia (WS)

Correspondence Address: LEONG C LEI, PMB # 1008, 1867 YGNACIO VALLEY ROAD, WALNUT CREEK, CA, 94598, US

(21) Appl. No.: 12/182,149

(22) Filed: Jul. 30, 2008

(51) Int. Cl. A63B 59/06; B29C 71/02

(52) U.S. Cl. 473/564; 264/345

(57) ABSTRACT

The method first provides a tubular outer member, a tubular inner member, and a head cap. Then, the inner member is threaded into the outer member and sealed inside by the head cap. The assembly is then placed in a mold, heated, and pressurized into a baseball bat. Due to its dual-layered structure, the baseball bat is capable of delivering superior performance and shock absorption. A material different from that of the outer and inner members could be further stuffed between the outer and inner members.

### TECHNICAL FIELD OF THE INVENTION

The present invention generally relates to baseball bats, and more particularly to a structure of composite baseball bats and a manufacturing method making such baseball bats.

### DESCRIPTION OF THE PRIOR ART

A conventional composite baseball bat is made in accordance with the steps depicted in the flow chart of FIG. 1. First of all, fibers are knitted or woven into pieces of cloth. These pieces of cloth are then cut into sheets of various shapes.

As shown in FIG. 2, these fiber sheets 1 are wrapped manually around a mandrel 2. These sheets 1, jointly having the shape of a baseball bat, are removed altogether from the mandrel 2 and a head cap 3 is used to cover a top end of the assembly of the sheets 1, as illustrated in FIG. 3. The assembly is placed in a mold and then heated and pressurized. Finally, after some decoration and coating, a composite baseball bat is thus formed.

When the sheets 1 are wrapped around the mandrel 2, they have to be properly overlapped. Otherwise, the baseball bat would have inferior strength at where there is too little or improper overlapping. Therefore, only experienced workers are capable of getting the task done correctly. More importantly, the sheets 1 cannot provide adequate shock absorption and most of the counterforce of hitting a baseball is passed directly to the hitter. It is quite often that the hitter's hands are numb or even injured. Additionally, such a composite baseball bat has inferior strength and restitution so that a baseball being hit could only fly for a shorter distance and height.

### SUMMARY OF THE INVENTION

Therefore, a first objective of the present invention is to provide a manufacturing method for composite baseball bats. The method first provides a tubular outer member, a tubular inner member, and a head cap. Then, the inner member is threaded into the outer member and sealed inside by the head cap. The assembly is then placed in a mold, heated, and pressurized into a baseball bat.

A second objective of the present invention is to provide a composite baseball bat having a dual-layered structure capable of delivering superior strength and restitution so that a baseball being hit could fly for a larger height and distance.

A third objective of the present invention is to provide a composite baseball bat having a dual-layered structure capable of providing superior shock absorption to prevent uncomfortable feeling and injury to a hitter's hands.

A material different from that of the outer and inner members could be stuffed between the outer and inner members so as to provide enhanced shock absorption and performance to the baseball bat.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the steps of a conventional method of making a composite baseball bat.

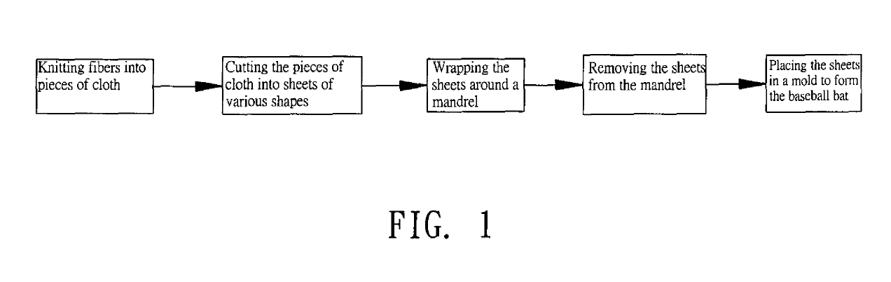

FIG. 2 is a schematic diagram showing the wrapping of fiber clothes around a mandrel according to the conventional method of FIG. 1.

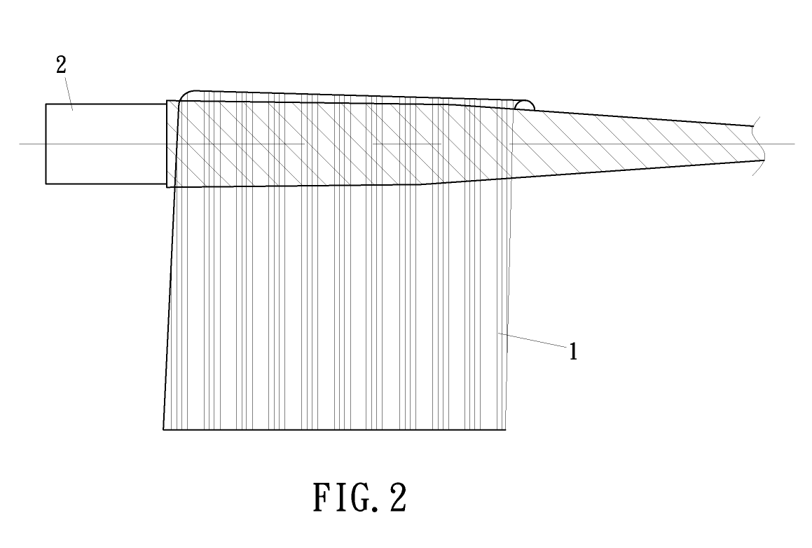

FIG. 3 is a schematic diagram showing a composite baseball bat manufactured in accordance with the conventional method of FIG. 1.

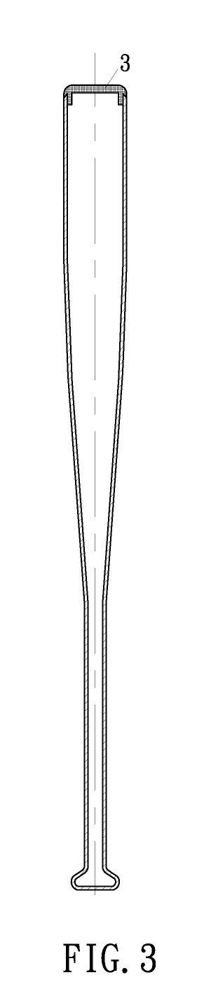

FIG. 4 is a schematic diagram showing a baseball bat according a first embodiment of the present invention.

FIG. 5 is a schematic diagram showing a baseball bat according a second embodiment of the present invention.

FIG. 6 is a schematic diagram showing a baseball bat according a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

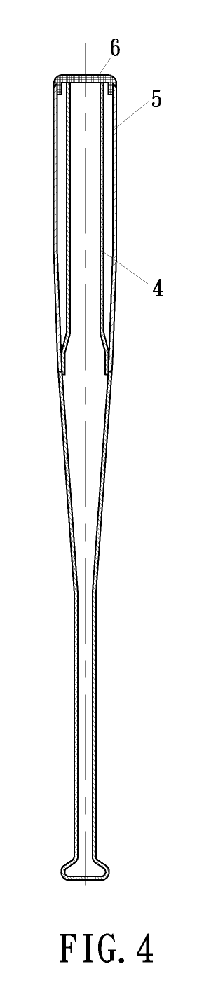

A baseball bat according to a first embodiment of the present invention contains a tubular outer member 5, a tubular inner member 4, and a head cap 6. The inner member 4 is threaded into a first end of the outer member 5 until a second end of the inner member 4 is confined by a middle section of the outer member 5 having a smaller diameter. The head cap 6 is then plugged into the outer and inner members 5 and 4's first ends. The resulted assembly is then placed into a mold, heated and pressurized into what is shown in FIG. 4.

As illustrated, the baseball bat thus has a dual-layered structure in a top section for hitting a baseball. The inner member 4, on one hand, effectively absorbs the shock when hitting a baseball and therefore could reduce and prevent the uncomfortable feeling and injury to the hitter. On the other hand, the dual-layered structure of the baseball bat provides enhanced strength and restitution so that the baseball being hit could fly for greater height and distance.

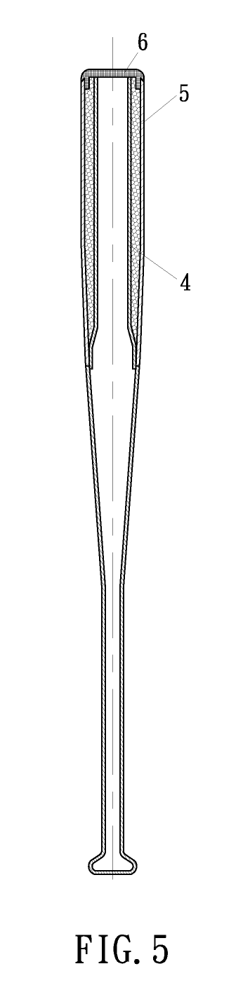

As shown in FIG. 5, a baseball bat according to a second embodiment of the present invention further contains a cushion layer (shown as the patterned area in the drawing) made of a foam or similar material that is different from those of the inner and outer members 4 and 5, stuffed between the inner and outer members 4 and 5. By integrating this heterogeneous material inside the baseball bat, the present embodiment is able to deliver even better shock absorption and hitting performance.

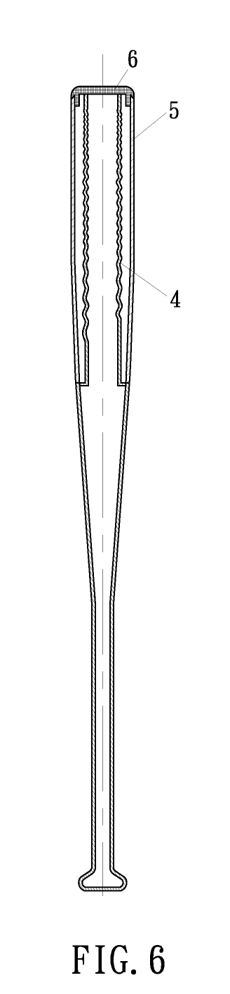

As shown in FIG. 6, a baseball bat according to a third embodiment of the present invention further provides thread grooves around an outer surface of the inner member 4. This arrangement will also provide enhanced shock absorption and hitting performance. Additionally, when the above-mentioned foam or similar material is stuffed between the inner and outer members 4 and 5, the thread grooves will provide superior bonding between the foam material and the inner member 4.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of making a composite baseball bat, comprising the steps of:
providing a tubular outer member, a tubular inner member, and a head cap;
threading said inner member into said outer member via a first end of said outer member until a second end of said inner member is confined by a middle section of said outer member;
plugging said head cap into said inner and outer members' first ends; and
placing the assembly of said inner member, outer member, and head cap thus formed into a mold, and heating and pressurizing said assembly into said composite baseball bat.

2. A composite baseball bat, comprising
a hollow outer member having a shape of a baseball bat;
a hollow tubular inner member inside a top section of said outer member; and
a head cap sealing a top end of said outer member.

3. The composite baseball bat according to claim 2, wherein a material different from those of said inner and outer members is stuffed between said inner and outer members.

4. The composite baseball bat according to claim 2, wherein a foam material is stuffed between said inner and outer members.

5. The composite baseball bat according to claim 1, wherein a plurality of thread grooves are provided around an outer surface of said inner member.
